(19) United States
(12) Patent Application Publication
(10) Pub. No.: US 2012/0232934 A1
(43) Pub. Date: Sep. 13, 2012

(54) AUTOMATED INSURANCE POLICY FORM GENERATION AND COMPLETION

(75) Inventors: Yi Zhang, Bothell, WA (US); Harry Snyder, Sammamish, WA (US)

(73) Assignee: VERTAFORE, INC., Bothell, WA (US)

(21) Appl. No.: 13/046,501

(22) Filed: Mar. 11, 2011

(51) Int. Cl. G06Q 40/00; G06Q 10/00

(52) U.S. Cl. 705/4; 705/342

(57) ABSTRACT

Automated insurance policy form generation and completion includes electronically receiving one or more forms and receiving an indication that a particular form is an overflow form for a particular base form. The relationship between the overflow form and base form is recorded based on the received indication and the fields on the base form and overflow form are tagged according to a naming convention. The number of overflow forms to use is determined based on an amount of received data and by using the naming convention to determine a number of available fields on the base form and overflow forms.

### BACKGROUND

1. Technical Field

This disclosure generally relates to data services, and to automated form generation and completion.

2. Description of the Related Art

Insurance agents (i.e., general agents) often compile a repository of insurance endorsement forms, organize that collection and maintain the format and version of the forms over time separately for various different insurance carriers. These processes consume a high number of hours of working time and, due to the fact that many of the forms have similar appearances and file names, such processes can be prone to user error. The insurance carrier delegates which forms belong on a policy and apply rules for determining when those forms are mandatory or optional.

Some existing insurance policy issuance utilities require that the general agent maintain insurance policy document templates to which the user must attach the proper policy jackets and insurance endorsement forms. Some insurance policy systems have grouping mechanisms for this selection process. Otherwise, this manual selection process must be repeated for each time a policy is issued. These aforementioned document from collections often number in the hundreds. The time spent on this selection process can add up to hundreds of hours wasted each year, reducing the number of policies an individual insurance agent can process.

### BRIEF SUMMARY

A computer-implemented method may be summarized as including determining by at least one processor that an electronically stored form is an overflow form for a base form, wherein the overflow form and base form are electronically stored forms; recording on a non-transitory storage medium a relationship between the overflow form and the base form based on the determination that that the particular electronically stored form is an overflow form for the particular electronically stored base form; electronically tagging one or more fields on the base form and the overflow form according to a naming convention; receiving data with which to populate the one or more fields of the base form or overflow form; and automatically determining by the at least one processor a quantity of electronically stored overflow forms to use corresponding to the overflow form to accommodate the received data based on an amount of the received data and based at least in part on the naming convention.

The computer-implemented method may further include automatically populating the base form and the determined quantity of overflow forms with the received data.

The computer-implemented method may further include electronically making available to a remote entity the base form and the determined quantity of overflow forms for validation.

The automatically determining by at least one processor the quantity of electronically stored overflow forms to use may include determining whether a quantity of content sub-items of the received data corresponding to a field on the base form exceeds an array size of the field on the base form as indicated by an index number within a tag used to identify a last sub-field within the array on the base form; and if the quantity of content sub-items exceeds the array size of the field on the base form, then determining the quantity of overflow may form to use by: dividing an amount that the quantity of content sub-items exceeds the array size of the field on the base form by an array size of a corresponding field on an overflow form corresponding to the field on the base form to generate a resulting number; and rounding the resulting number up to the next whole number if the resulting number is not a whole number.

The computer-implemented method may further include repeating the determining whether the quantity of content sub-items of the received data corresponding to the field on the base form exceeds the array size and the determining the quantity of overflow forms to use, for each field of the base form.

One or more fields of the base form may have different corresponding overflow forms.

The computer-implemented method may further include automatically selecting a largest determined quantity of overflow forms from the determined quantities of overflow forms to use for each field; and using the selected largest quantity as a quantity of overflow forms to use for the base form.

The base form and the overflow forms may be electronically stored insurance policy forms and the received data includes one or more of insurance customer data and insurance customer property data.

A system may be summarized as including a computer processor; and a non-transitory memory communicatively coupled to the computer processor having computer-executable instructions stored thereon that when executed by the computer processor cause the computer processor to perform: determining that an electronically stored form is an overflow form for a base form, wherein the overflow form and base form are electronically stored forms; determining a quantity of electronically stored overflow forms to use corresponding to the overflow form to accommodate received data with which to populate the base form and the overflow form, based on an amount of the received data and based at least in part on a naming convention for tags of fields on the base form and tags of fields on the overflow form; and automatically populating the base form and the determined quantity of overflow forms with at least a portion of the received data.

The computer-executable instructions, when executed by the computer processor, may further cause the computer processor to perform: receiving an indication that a particular electronically stored form is the overflow form for the base form; and recording a relationship between the overflow form and the base form based on the received indication. The computer-executable instructions, when executed by the computer processor, may further cause the computer processor to perform electronically tagging the fields on the base form and the fields on the overflow form according to the naming convention. Determining the quantity of electronically stored overflow forms to use may include determining whether a quantity of content sub-items of the received data corresponding to a field on the base form exceeds an array size of the field on the base form as indicated by an index number within a tag used to identify a last sub-field within the array on the base form; and if the quantity of content sub-items exceeds the array size of the field on the base form, then determining the quantity of overflow forms to use by dividing an amount that the quantity of content sub-items exceeds the array size of the field on the base form by an array size of a corresponding field on an overflow form corresponding to the field on the base form to generate a resulting number; and rounding the resulting number up to the next whole number if the resulting number is not a whole number. The base form and the overflow forms may be electronically stored insurance policy forms and the received data includes one or more of insurance customer data and insurance customer property data.

A non-transitory computer readable storage medium may be summarized as a non-transitory computer-readable storage medium having computer computer-executable instructions stored thereon that when executed by a computer processor cause the computer processor to perform: determining a quantity of available fields on a base form and an overflow form associated with the base form based at least in part on a naming convention for tags of fields of the base form and tags of fields of the overflow form, wherein the overflow form and the base form are electronically stored forms; and automatically determining, based on the determined quantity of available fields on the base form and the overflow form, a quantity of electronically stored overflow forms to use corresponding to the overflow form to accommodate received data with which to populate the base form and overflow forms.

The computer-executable instructions, when executed by the computer processor, may further cause the computer processor to perform: electronically receiving one or more electronically stored forms; receiving an indication that a particular form is the overflow form associated with the base form, one or more of the overflow form and base form being of the received one or more electronically stored forms; and recording a relationship between the overflow form and the base form based on the received indication. The computer-executable instructions, when executed by the computer processor, may further cause the computer processor to perform electronically tagging fields on the base form and overflow form according to the naming convention. The determining a quantity of available fields on the base form and the overflow form based at least in part on the naming convention may include determining an array size of a field on the base form as indicated by an index number within a tag used to identify a last sub-field within the array on the base form. The automatically determining, based on the determined quantity of available fields on the base form and the overflow form, the quantity of electronically stored overflow forms to use may include if a quantity of content sub-items of the received data corresponding to the field on the base form exceeds the array size of the field on the base form, then determining the quantity of overflow forms to use by: dividing an amount that the quantity of content sub-items exceeds the array size of the field on the base form by an array size of a corresponding field on an overflow form corresponding to the field on the base form to generate a resulting number; and rounding the resulting number up to the next whole number if the resulting number is not a whole number. The base form and the overflow forms may be electronically stored insurance policy forms and the received data may include one or more of insurance customer data and insurance customer property data. The computer-executable instructions, when executed by the computer processor, may further cause the computer processor to perform electronically making available to a remote entity a completed base form and a completed determined quantity of overflow forms for validation.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn are not intended to convey any information regarding the actual shape of the particular elements, and have been solely selected for ease of recognition in the drawings.

FIG. 1 is a system diagram of a networked environment, in which systems, devices and methods for automated insurance policy form generation and completion may be a part, or in which they it be implemented, according to one illustrated embodiment.

FIG. 2 is a schematic diagram of an example computer system of any one of the entities or systems of FIG. 1, suitable for implementing automated insurance policy form generation and completion, according to one illustrated embodiment.

FIG. 3 is a flow diagram illustrating an automated process of insurance policy quoting of which automated insurance policy form generation and completion may be a part, according to one illustrated embodiment.

FIG. 4 is a flow diagram illustrating an automated process of insurance policy issuance of which automated insurance policy form generation and completion may be a part, according to one illustrated embodiment.

FIG. 5 is a flow diagram illustrating an automated process of insurance policy endorsement of which automated insurance policy form generation and completion may be a part, according to one illustrated embodiment.

FIG. 6 is a block diagram showing the flow of data between components of a policy issuance system which implements automated insurance policy form generation and completion, according to one illustrated embodiment.

FIG. 7 is a flow diagram illustrating a process of automated insurance policy form generation and completion, according to one illustrated embodiment.

FIG. 8 is a flow diagram illustrating an automated process for determining the number of overflow forms to use in the process of insurance policy form generation and completion of FIG. 7, according to one illustrated embodiment.

FIG. 9 is an example base form showing field names and associated tags that may be used in automated insurance policy form generation and completion, according to one illustrated embodiment.

FIG. 10 is an example overflow form associated with the base form of FIG. 9, showing field names and associated tags that may be used in automated insurance policy form generation and completion, according to one illustrated embodiment.

FIG. 11 is the example base form of FIG. 9, populated with data resulting from automated insurance policy form generation and completion, according to one illustrated embodiment.

FIG. 12 is an example overflow form associated with the base form of FIG. 11, populated with data resulting from automated insurance policy form generation and completion, according to one illustrated embodiment.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with computing systems including client and server computing systems, as well as networks, including various types of telecommunications networks, have not been shown or described in detail to avoid unnecessarily obscuring descriptions of the embodiments.

Unless the context requires otherwise, throughout the specification and claims which follow, the word “comprise” and variations thereof, such as “comprises” and “comprising,” are to be construed in an open, inclusive sense, that is, as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

The headings and Abstract of the Disclosure provided herein are for convenience only and do not interpret the scope or meaning of the embodiments.

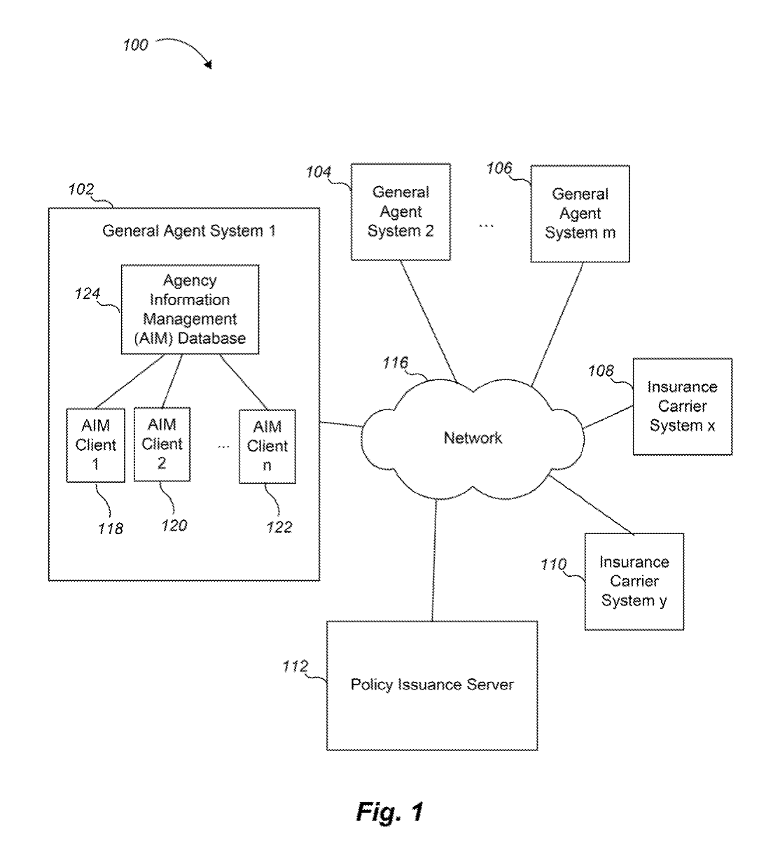

FIG. 1 is a system diagram of a networked environment, in which systems, devices and methods for automated insurance policy form generation and completion may be a part, or in which they it be implemented, according to one illustrated embodiment.

The networked environment 100 may include one or more general agent (e.g., insurance agent) systems, such as general agent system 1 102, general agent system 2 104, and general agent system m 106; one or more insurance carrier systems, such as insurance carrier system x 108 and insurance carrier system y 110; and a policy (e.g., insurance policy) issuance server 112. General agent system 1 102, general agent system 2 104, general agent system m 106, insurance carrier system x 108, insurance carrier system y 110, and the policy issuance server 112 may all be communicatively coupled via a network 116. Alternatively, one or more of the systems or devices may be located on a single system and/or at a single physical location. Additional systems and devices may also be present, but are not illustrated for clarity of presentation.

A general agent system, e.g., general agent system 102, may include an agency information management (AIM) database 124 that stores insurance customer or property data included, or that may be included, on an insurance policy. Other insurance policy information may also be stored on the AIM database 124. One or more AIM clients, such as AIM client 1 118, AIM client 2 120 and AIM client n 122, may be communicatively connected to the AIM database 124 such that the insurance customer data or property data can be collected and stored in the AIM database 124 and subsequently accessed, modified or deleted via the one or more AIM clients 118 120 122. For example, in some cases a server installation of the AIM database is shared to the AIM clients 118 120 122. This may be implemented using Citrix® networking software provided by Citrix Systems, Inc. located in Fort Lauderdale, Fla. However, other networking software may instead or also be used. The AIM clients 118 120 122 retrieve raw policy data from the AIM database 124 and convert that data into a standardized format such as Association for Cooperative Operations Research and Development Extensible Markup Language (ACORD XML). That XML is sent to the policy issuance server 112 over network 116. However, the raw data may be converted into other standardized formats including other declarative programming language formats, among others.

The policy issuance server 112 may provide the general agent systems 102 104 106 the ability to process and issue insurance policies and policy endorsements using a policy issuance web service of the policy issuance server 112. The policy issuance and policy endorsement process may include customized automated compiling, completion, validation and/or verification, of various policy forms and forms packages originating from or provided by the one or more insurance carriers 108 110 using insurance customer or property data information gathered by the one or more general agent systems 102 104 106 and/or provided by the one or more general agent systems 102 104 106 to the policy issuance server 112. For example, general agent system 1 102 may electronically collect data from an insurance customer and provide such data to the policy issuance server 112 in a specified format. The policy issuance server 112 will then compile that data and automatically complete the applicable insurance policy forms for the particular insurance carrier (e.g. insurance carrier 110) based on form templates generated by the policy issuance server 112, insurance carrier 110 and/or the general agent system 102 and communicate the completed insurance policy package back to the general agent system 102 for further verification and/or validation before ultimately issuing the policy.

The network 116 may be any computer network, telecommunications network or combination of telecommunications and computer networks that enables communication between the various systems and entities connected to the network 116 shown in FIG. 1. General agent system 1 102, general agent system 2 104, general agent system m 106, insurance carrier system x 108, insurance carrier system y 110, and the policy issuance server 112 may be additionally or optionally linked by one or more other communication links or networks that comprise network 116. For example, a communications network of network 116 may include a local area network that uses wireless fidelity (Wi-Fi) high frequency radio signals to transmit and receive data over distances of a few hundred feet. The local area network may be a wireless local area network (WLAN) based on the Institute of Electric and Electronic Engineers (IEEE) 802.11 standards. However, other wired and wireless communications networks and protocols may be used to link the various entities and systems shown in FIG. 1.

The network 116 may comprise connections to the general agent system 1 102, general agent system 2 104, general agent system m 106, insurance carrier system x 108, insurance carrier system y 110, and the policy issuance server 112 such that the policy issuance server 112 may provide the general agent systems 102 104 106 the ability to process and issue insurance policies and policy endorsements using the policy issuance web service of the policy issuance server 112, and may itself represent multiple interconnected networks. For instance wired and wireless enterprise-wide computer networks, intranets, extranets, and/or the Internet may be included in or comprise a part of network 116. Embodiments may include various types of communication networks including other telecommunications networks, cellular networks, and other mobile networks. There may be any variety of computers, switching devices, routers, bridges, firewalls, edge devices, multiplexers, phone lines, cables, telecommunications equipment and other devices within network 116 and/or in the communications paths between the systems and entities of FIG. 1.

In accordance with an aspect of the disclosure, the systems and/or systems shown in FIG. 1 may contain discrete functional program modules that might make use of an application programming interface (API), or other object, software, firmware and/or hardware, to request or provide services of one or more of the other entities or systems within or connected to the network 116. For example, communication can be provided over a communications medium, e.g., client and server systems running on any one of the systems or systems of the entities shown in FIG. 1.

These client and server systems may be communicatively coupled to one another via transmission control protocol/internet protocol (TCP/IP) connection(s) for high-capacity communication. The “client” is a member of a class or group that uses the services of another class or group to which it is not related. In computing, a client is a process, i.e., roughly a set of instructions or tasks, executed by hardware that requests a service provided by another program. Generally, the client process utilizes the requested service without having to “know” any working details about the other program or the service itself. In a client/server architecture, particularly a networked system, a client is usually a computer or device that accesses shared network resources provided by another computer or device, e.g., a server. Any system in FIG. 1, including the general agent system 1 102, general agent system 2 104, general agent system m 106, insurance carrier system x 108, insurance carrier system y 110, the policy issuance server 112, the AIM database 124 and the one or more AIM clients 118 120 122, can be considered a client, a server, or both, depending on the circumstances.

Although the physical environment of the network 116 may have connected devices such as computers, the physical environment may alternatively have or be described as comprising various digital devices such as personal digital assistants (PDAs), televisions, MP3 players, etc., software objects such as interfaces, Component Object Model (COM) objects and the like.

There are a variety of systems, components, and network configurations that may also support distributed computing environments within the network 116. For example, computing systems may be connected together within the network 116 by wired or wireless systems, by local networks or by widely distributed networks. Currently, many networks are coupled to the Internet, which provides an infrastructure for widely distributed computing and encompasses many different networks. Any such infrastructures, whether coupled to the Internet or not, may be used in conjunction with, be connected to, or comprise part of the network 116.

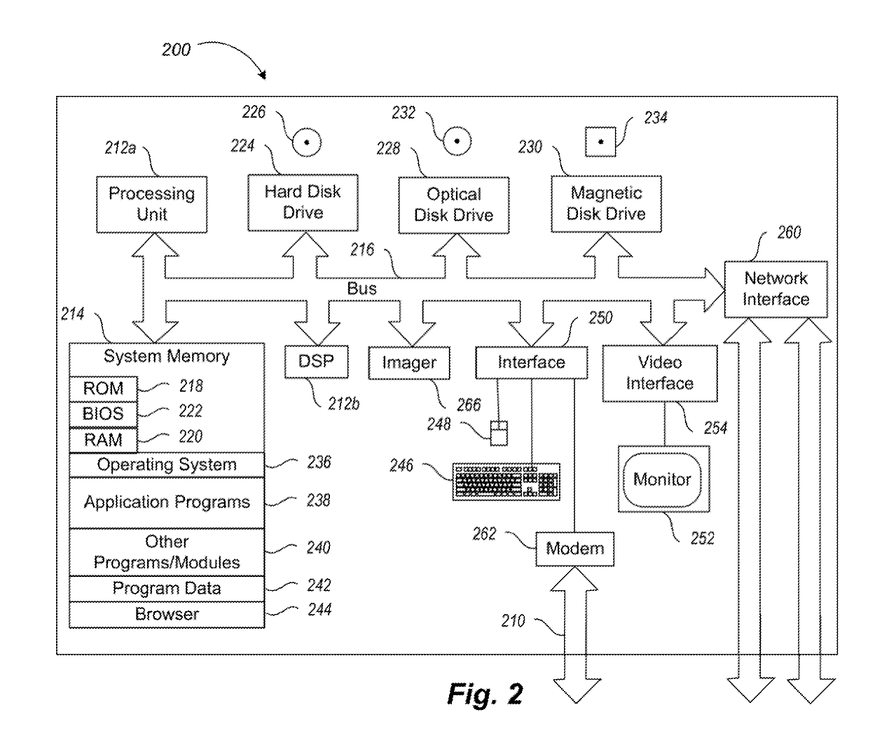

FIG. 2 is a schematic diagram of an example computer system of any one of the entities or systems of FIG. 1, suitable for implementing automated insurance policy form generation and completion, according to one illustrated embodiment.

The computer system 200 is suitable for implementing systems, devices and methods for automated insurance policy form generation and completion, according to one illustrated embodiment. The computer system 200 will at times be referred to in the singular herein, but this is not intended to limit the embodiments to a single device since in typical embodiments, there may be more than one computer system or devices involved. Unless described otherwise, the construction and operation of the various blocks shown in FIG. 2 are of conventional design. As a result, such blocks need not be described in further detail herein, as they will be understood by those skilled in the relevant art.

The computer system 200 may include one or more processing units 212a, 212b (collectively 212), a system memory 214 and a system bus 216 that couples various system components including the system memory 214 to the processing units 212. The processing units 212 may be any logic processing unit, such as one or more central processing units (CPUs) 212a, digital signal processors (DSPs) 212b, application-specific integrated circuits (ASICs), programmable gate arrays such as field programmable gate arrays (FPGAs), etc. The system bus 216 can employ any known bus structures or architectures, including a memory bus with memory controller, a peripheral bus, and a local bus. The system memory 214 includes read-only memory (“ROM”) 218 and random access memory (“RAM”) 220. A basic input/output system (“BIOS”) 222, which can form part of the ROM 218, contains basic routines that help transfer information between elements within the computer system 200, such as during start-up.

The computer system 200 may include a hard disk drive 224 for reading from and writing to a hard disk 226, an optical disk drive 228 for reading from and writing to removable optical disks 232, and/or a magnetic disk drive 230 for reading from and writing to magnetic disks 234. The optical disk 232 can be a CD-ROM, while the magnetic disk 234 can be a magnetic floppy disk or diskette. The hard disk drive 224, optical disk drive 228 and magnetic disk drive 230 may communicate with the processing unit 212 via the system bus 216. The hard disk drive 224, optical disk drive 228 and magnetic disk drive 230 may include interfaces or controllers (not shown) coupled between such drives and the system bus 216, as is known by those skilled in the relevant art. The drives 224, 228 and 230, and their associated computer-readable storage media 226, 232, 234, may provide nonvolatile and non-transitory storage of computer readable instructions, data structures, program modules and other data for the computer system 200. Although the depicted computer system 200 is illustrated employing a hard disk 224, optical disk 228 and magnetic disk 230, those skilled in the relevant art will appreciate that other types of computer-readable storage media that can store data accessible by a computer may be employed, such as magnetic cassettes, flash memory, digital video disks (“DVD”), Bernoulli cartridges, RAMs, ROMs, smart cards, etc. For example, computer-readable storage media may include, but is not limited to, random access memory (RAM), read-only memory (ROM), electrically erasable programmable read-only memory (EEPROM), flash memory, compact disc ROM (CD-ROM), digital versatile disks (DVD) or other optical disk storage, magnetic cassettes, magnetic tape, magnetic disk storage or other magnetic storage devices, solid state memory or any other medium which can be used to store the desired information and which may be accessed by processing unit 212a.

Program modules can be stored in the system memory 214, such as an operating system 236, one or more application programs 238, other programs or modules 240 and program data 242. Application programs 238 may include instructions that cause the processor(s) 212 to provide automated insurance policy form generation and completion such as, for example, automated insurance policy form generation and completion performed during the policy issuance service provided by the policy issuance server 112 based on insurance customer and property data received by the general agent system 102. Other program modules 240 may include instructions for handling security such as password or other access protection and communications encryption. The system memory 214 may also include communications programs, for example, a Web client or browser 244 for permitting the computer system 200 to access and exchange data with sources such as Web sites of the Internet, corporate intranets, extranets, or other networks and devices as described herein, as well as other server applications on server computing systems. The browser 244 in the depicted embodiment is markup language based, such as Hypertext Markup Language (HTML), Extensible Markup Language (XML) or Wireless Markup Language (WML), and operates with markup languages that use syntactically delimited characters added to the data of a document to represent the structure of the document. A number of Web clients or browsers are commercially available such as those from Mozilla, Google, and Microsoft of Redmond, Wash.

While shown in FIG. 2 as being stored in the system memory 214, the operating system 236, application programs 238, other programs/modules 240, program data 242 and browser 244 can be stored on the hard disk 226 of the hard disk drive 224, the optical disk 232 of the optical disk drive 228 and/or the magnetic disk 234 of the magnetic disk drive 230.

An operator can enter commands and information into the computer system 200 through input devices such as a touch screen or keyboard 246 and/or a pointing device such as a mouse 248, and/or via a graphical user interface. Other input devices can include a microphone, joystick, game pad, tablet, scanner, etc. These and other input devices are connected to one or more of the processing units 212 through an interface 250 such as a serial port interface that couples to the system bus 216, although other interfaces such as a parallel port, a game port or a wireless interface or a universal serial bus (“USB”) can be used. A monitor 252 or other display device is coupled to the system bus 216 via a video interface 254, such as a video adapter. The computer system 200 can include other output devices, such as speakers, printers, etc.

The computer system 200 can operate in a networked environment using logical connections to one or more remote computers and/or devices as described above with reference to FIG. 1. For example, the computer system 200 can operate in a networked environment using logical connections to one or more mobile devices, landline telephones and other service providers or information servers. Communications may be via a wired and/or wireless network architecture, for instance wired and wireless enterprise-wide computer networks, intranets, extranets, telecommunications networks, cellular networks, paging networks, and other mobile networks.

Although not required, the embodiments will be described in the general context of computer-executable instructions, such as program application modules, objects, or macros stored on computer- or processor-readable storage media and executed by a computer or processor. Those skilled in the relevant art will appreciate that the illustrated embodiments as well as other embodiments can be practiced with other system configurations and/or other computing system configurations, including hand-held devices, multiprocessor systems, microprocessor-based or programmable consumer electronics, personal computers (“PCs”), network PCs, mini computers, mainframe computers, and the like. The embodiments can be practiced in distributed computing environments where tasks or modules are performed by remote processing devices, which are linked through a communications network such as network 116. In a distributed computing environment, program modules may be located in both local and remote memory storage devices.

Agency information management (AIM) systems may offer the user built-in options to issue insurance policies. These built-in options vary from internally generating the document directly from policy data, to sending policy data to word processing utilities which generate the actual document using templates. External policy issuance utilities may also follow this model, and accept policy data which is then placed in pre-defined locations and eventually produce a policy document in a similar manner. Although each of these approaches addresses certain difficulties inherent to issuing insurance policies, there still exists the potential of user error surrounding the issuance process and may also involve an excessive amount of time to maintain these systems.

Advantageously, the embodiments of the general agent system described herein instead or additionally provide an integration library and associated programs that produce policy data in a standardized declarative language format (e.g., in Association for Cooperative Operations Research and Development Extensible Markup Language (ACORD XML)), which is then transmitted to the policy issuance server 112. Note that the transmitted XML need not communicate to the policy issuance server 112 where to place the data on any particular policy document or form, and the user (e.g., the general agent) need not have seen the policy form templates nor its endorsement forms prior to using the system. This substantially reduces potential of user error surrounding the policy issuance process and also reduces the amount of time to maintain the general agent systems.

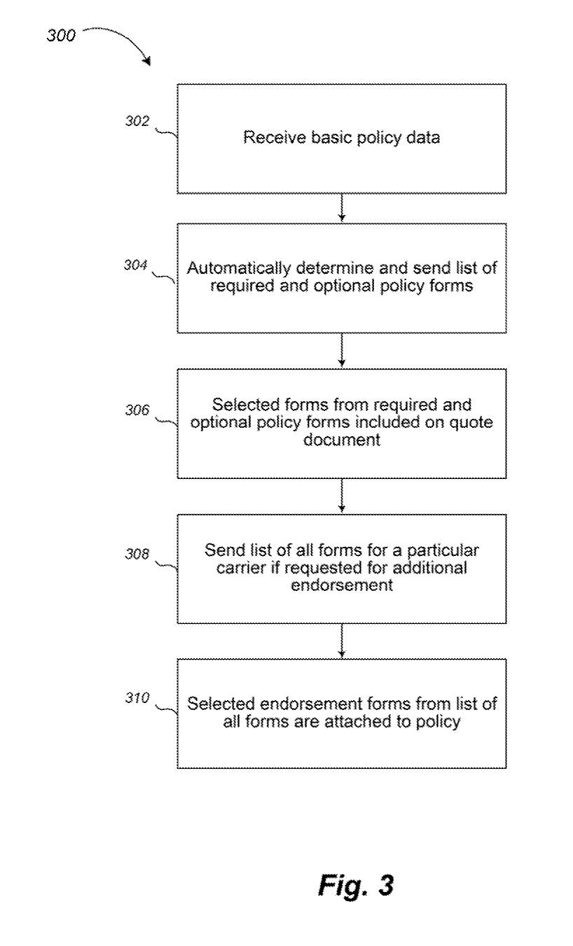

FIG. 3 is a flow diagram illustrating an automated process 300 of insurance policy quoting of which automated insurance policy form generation and completion may be a part, according to one illustrated embodiment.

The process 300 starts at 302, wherein the basic policy data is received by the policy issuance server (e.g., in ACORD XML format). For example, the general agent or other user may enter basic policy data into the general agent system, and then send a request that includes the basic policy data to the policy issuance server for a list of required and optional policy forms based on the received basic policy data.

At 304, based on the received policy data, the policy issuance server automatically determines and sends the list of required and optional policy forms to the general agent system. The policy issuance server may use the received policy data to determine the listed optional forms, and those that are marked as required for the particular policy. The policy issuance server may automatically apply custom business rules for each individual insurance carrier to compile policy documents, automating an otherwise typically error-prone and time consuming process. The policy issuance server may automatically generate the insurance policy form templates, including overflow forms, based on forms previously received corresponding to the applicable insurance carrier and then populate the forms with the appropriate received basic policy data.

At 306, the general agent system selects forms from the required and optional policy forms to include on an insurance quote document.

At 308, the policy issuance server may send a list of all forms for a particular carrier to the general agent if requested for an additional endorsement to the policy being quoted. For example, if the user decides that an endorsement form that is not listed needs to be attached to the policy, they can request a list of all of the forms the corresponding carrier has made available to the general agent.

At 310, the general agent system attaches the selected endorsement forms to the policy.

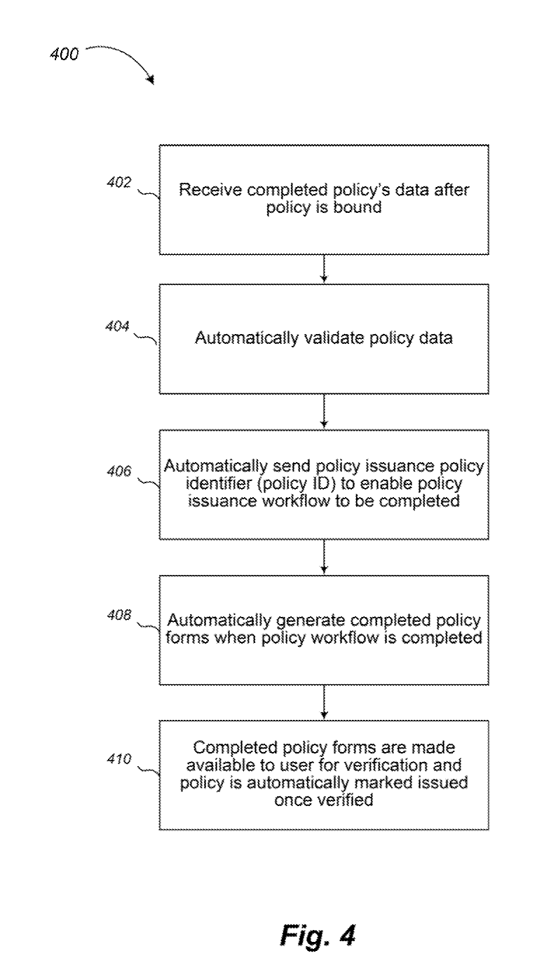

FIG. 4 is a flow diagram illustrating an automated process 400 of insurance policy issuance of which automated insurance policy form generation and completion may be a part, according to one illustrated embodiment.

At 402, after the policy has been bound, the general agent system may then submit the completed policy's data, exported to ACORD XML, to the policy issuance server.

At 404, the policy issuance server automatically validates the policy data to ensure the policy is valid.

At 406, if the policy is valid, the policy issuance server sends a policy issuance policy identifier (policy ID) to enable the policy issuance workflow to be completed by the general agent. For example, this new ID is used to generate a uniform resource locator (URL) to a web page on the policy issuance server that will allow the user to complete the service's issuance workflow.

At 408, based on the received policy data, the policy issuance server automatically generates completed policy forms (e.g., in Adobe® portable document format (PDF)) when the policy workflow is completed. For example, the policy issuance server may automatically generate the insurance policy form templates, including overflow forms, based on forms received from the corresponding insurance carrier and then populate the forms with the applicable received policy data.

At 410, the completed policy forms are made available to the user for verification and the policy is automatically marked issued once verified. For example, the general agent system polls another generated URL, again using the policy ID, until a link to the issued policy's PDF URL is available. Once the PDF's link is retrieved, the PDF is downloaded, saved to the general agent system's attachment directory, logged to the general agent system's activity log and displayed to the user for validation. The policy can be modified and re-issued until the policy has been marked as issued on policy issuance server. After the policy has been issued and verified, the general agent can then mail out the policy. This also marks the policy as completed on the policy issuance server. Once the policy has been mailed out, it may be modified by an endorsement.

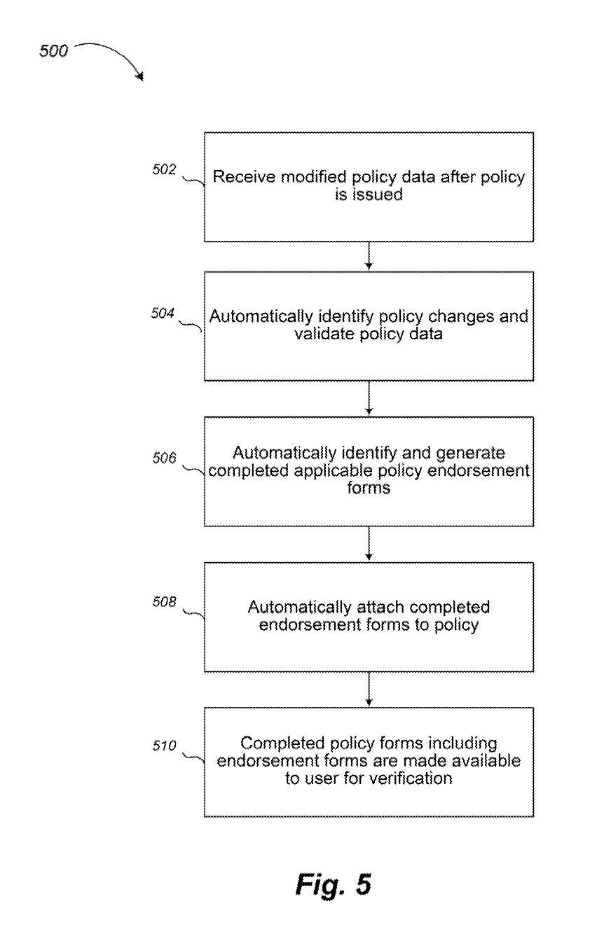

FIG. 5 is a flow diagram illustrating an automated process 500 of insurance policy endorsement of which automated insurance policy form generation and completion may be a part, according to one illustrated embodiment.

At 502, the policy issuance server receives modified policy data after the policy is issued.

At 504, the policy issuance server automatically identifies policy changes and validates policy data.

At 506, based on the received modified policy data, the policy issuance server automatically identifies and generates completed applicable policy endorsement forms. For example, the policy issuance server may automatically generate the insurance policy endorsement form templates, including overflow forms, based on forms received from the corresponding insurance carrier and then populate the forms with the applicable received policy data.

At 510, the completed policy forms including endorsement forms are made available to the user for verification (e.g., by the policy issuance server automatically posting a link to the completed endorsement forms or sending a link to the completed endorsement forms to the general agent system).

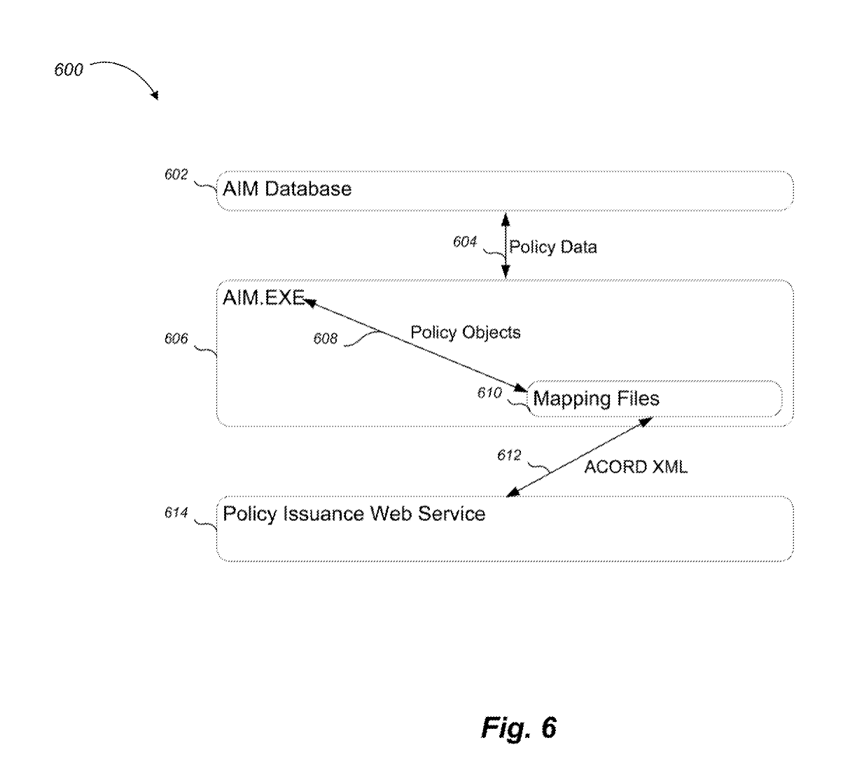

FIG. 6 is a block diagram showing the flow of data 600 between components of a policy issuance system which implements automated insurance policy form generation and completion, according to one illustrated embodiment.

Internally, the general agent system may use mapping files 610 to export policy data 604 retrieved from the AIM database 602 as valid ACORD XML 612. These mapping files 610 may also be formatted as XML and are distributed with the AIM client 606 software (e.g., AIM.exe). These mapping files 610 can be broken into parts, which are compiled into a full map file before being processed by AIM client software 606. The appropriate mapping files are loaded based on the policy's line(s) of business that are currently being exported. Before the mapping files are processed, the raw policy data 604 is loaded into policy objects 608 and it is these policy objects 608 that are directly mapped to ACORD XML.

In the mapping files 610, each of the policy objects 608 are represented as data sources and the pieces of data held by the object are represented as fields. The AIM client software 606 processes the map files sequentially, allowing the map files to dictate how the policy's objects are accessed and what data is being exported. The mapping files 610 takes these data sources and fields, and places them into ACORD XML nodes 612. The latter part of this process is also performed sequentially, allowing the AIM client software 606 to adhere to the ordering of the mapped ACORD XML nodes 612. This ACORD XML 612 is then communicated to the policy issuance web service 614 such that policy issuance server may automatically generate the insurance policy form templates, including overflow forms, based on forms received from the corresponding insurance carrier or other sources and then populate the forms with the applicable policy data of the received ACORD XML 612.

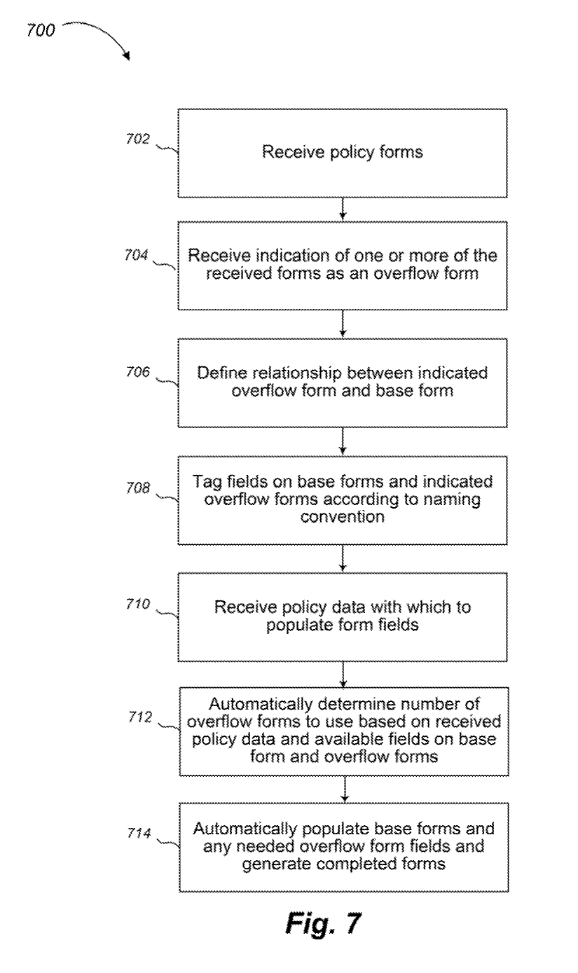

FIG. 7 is a flow diagram illustrating a process 700 of automated insurance policy form generation and completion, according to one illustrated embodiment.

Insurance policy forms are often a fixed size with a fixed number of fields to place data. Certain fields on the form come from a list of data that is of unknown size. If there isn't enough room on the form, then that data must “flow” onto another form (i.e., an overflow form). This other form may be a completely different form designed to contain this overflow data. There may be more than one of these fields on the original form (e.g. locations and classes of business). If one of the items overflows, then a new page will need to be used. The process 700 of automated insurance policy form generation and completion provides one embodiment to automate this overflow form process as part of or separate from the automated policy issuance process described above.

At 702, the applicable policy forms are received by the policy issuance server. These may be received from the insurance carrier, general agent or other party.

At 704, the policy issuance server receives an indication from the general agent or other entity that one or more of the received forms is an overflow form for another form. For example, one of the received forms may be designated an overflow form for another form of the received forms or for another previously received form. This other form may be referred to the base form. Also, another form of the received forms or another previously received form may be designated as an overflow form for one of the received forms. This designation or indication may be made and/or received electronically with or separate from the receiving of the form itself.

At 706, the policy issuance server defines the relationship between indicated overflow form and base form based on the received indication and records this relationship directly within the forms and/or separately from the forms.

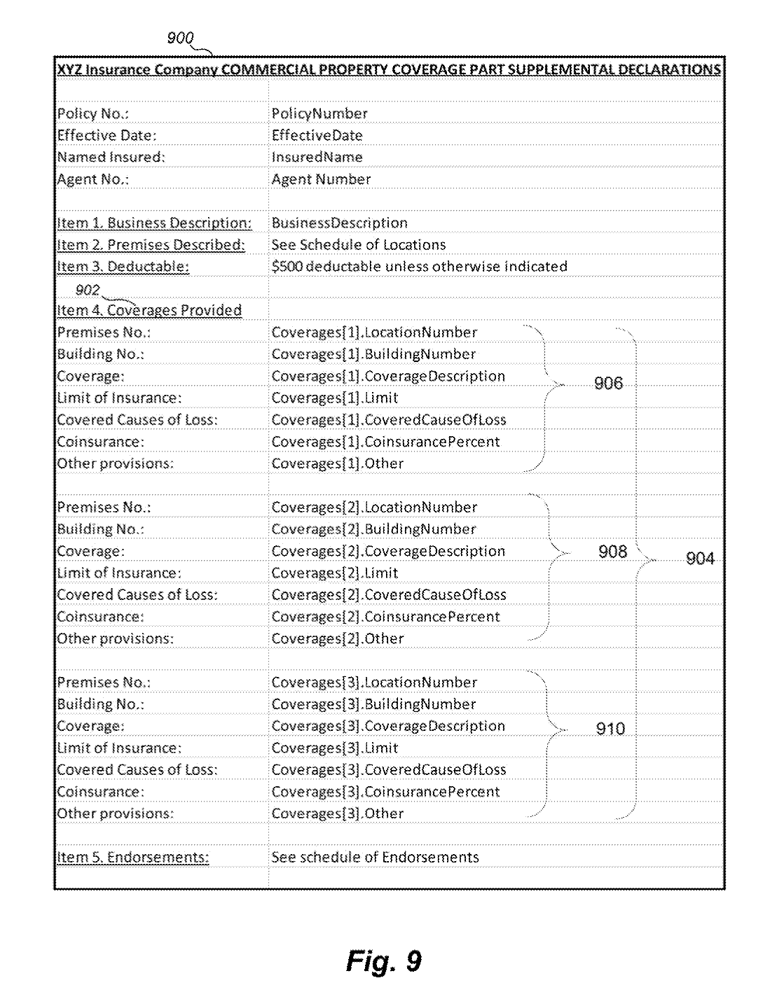

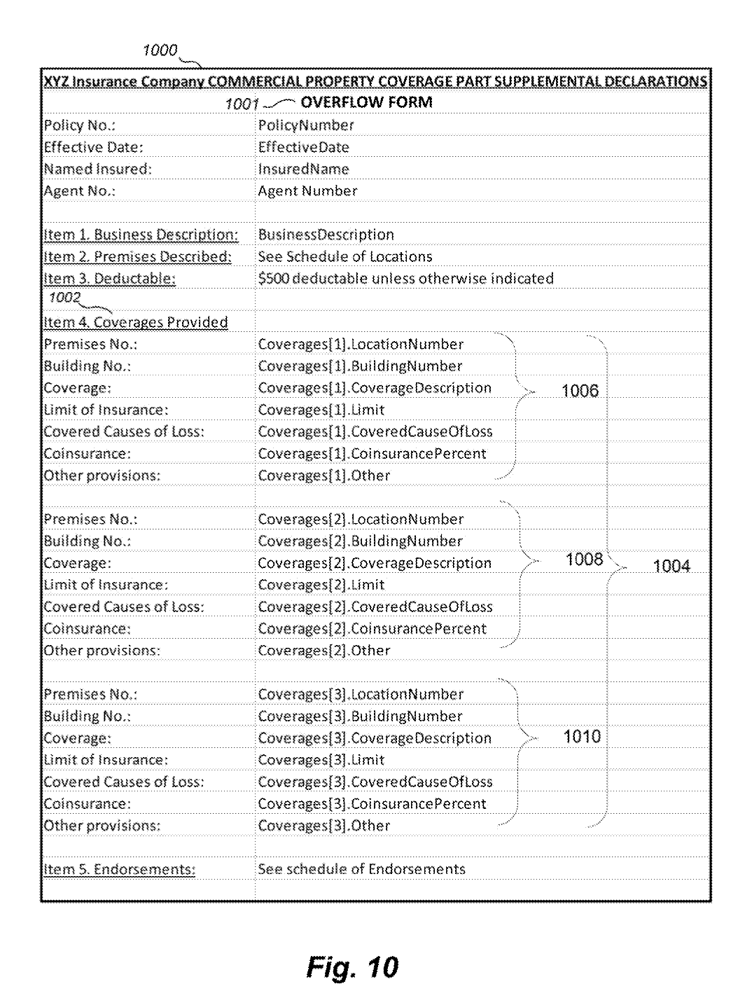

At 708, the policy issuance server tags fields on the base forms and indicated overflow forms according to a naming convention. For example, this naming convention may indicate how many sub-items or sub-fields a particular field may contain within an array for the particular form. FIG. 9 and FIG. 10 show tags according to one such example naming convention for a sample form.

At 710, the policy issuance server receives policy data from the general agent system with which to populate form fields. For example, this policy data may be received in the XML ACORD format as described above.

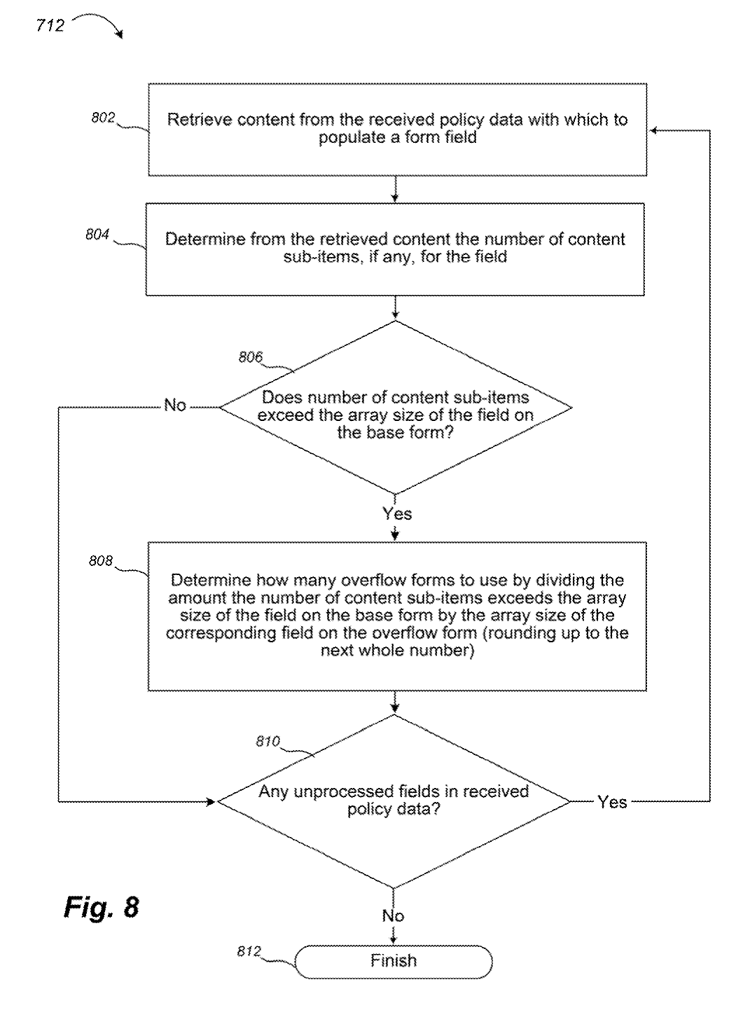

At 712, the policy issuance server automatically determines the number of overflow forms to use based on the received policy data and available fields on the base form and designated overflow forms. This may include dynamically determining the number of available fields on the base form and dynamically determining the number of overflow forms needed to handle all or part of the received policy data. One base form may have many different designated overflow forms each corresponding to a field determined to have data which will overflow. An example of this process to automatically determine the number of overflow forms is described further in FIG. 8.

At 714, the policy issuance server automatically populates the base forms and any needed overflow form fields and generates completed forms. These completed forms may then be made available to a user for verification and policy issuance as described above in the policy issuance process.

FIG. 8 is a flow diagram illustrating an automated process 712 for determining the number of overflow forms to use in the process of insurance policy form generation and completion of FIG. 7, according to one illustrated embodiment.

At 802, the policy issuance server retrieves content from the received policy data with which to populate a form field.

At 804, the policy issuance server determines from the retrieved content the number of content sub-items, if any, for the field.

At 806, the policy issuance server determines whether number of content sub-items exceeds the array size of the field on the base form.

At 808, if the policy issuance server had determined that the number of content sub-items exceeds the array size of the field on the base form, then the policy issuance server determines how many overflow forms to use by dividing the amount the number of content sub-items exceeds the array size of the field on the base form by the array size of the corresponding field on the overflow form (rounding up to the next whole number). If the policy issuance server had determined that the number of content sub-items does not exceed the array size of the field on the base form, then the process continues directly to 810 instead.

At 810, the policy issuance server determines whether there are any unprocessed fields in received policy data. For example, one form may have multiple fields which may each contain multiple content sub-items in sub-fields that could possibly need to overflow onto a same or different overflow form.

At 812, if the policy issuance server had determined there are not any unprocessed fields in received policy data, the process finishes. Otherwise, the process continues to 802 to continue processing fields which may need to contain data that might overflow onto an overflow form.

FIG. 9 is an example base form 900 showing example field names and associated tags that may be used in automated insurance policy form generation and completion, according to one illustrated embodiment. Shown is an example Coverages Provided section 902. The Coverages Provided section 902 includes three subsections which may be populated with content sub-items, such as insurance coverages for different buildings. However, if more than three buildings need coverage, an overflow form will be utilized. Each corresponding field within the three subsections is tagged according to a naming convention as shown wherein each subsection corresponds to a sub-field of the Coverages[] field 904 (which is an array of sub-fields) designated by a corresponding index integer. The first Coverages Provided subsection is indicated by the Coverages[1] sub-field 906, the second subsection is indicated by the Coverages[2] sub-field 908, and the third subsection is indicated by the Coverages[3] sub-field 910. The process issuance server determines the number of coverages fields available on the form (i.e., the array size of the Coverages[] field 904) by reading the largest available index number of the Coverages[] field 904. In this example, it is three since Coverages[3] 910 has the largest index number.

FIG. 10 is an example overflow form 1000 associated with the base form of FIG. 9, showing field names and associated tags that may be used in automated insurance policy form generation and completion, according to one illustrated embodiment. The overflow form 1000 in this case is similar to the base form 900 except that it has been previously indicated as an overflow form for form 900, as designated by the overflow form title 1001. It also has a Coverages Provided section 1002. The Coverages Provided section 1002 also includes three subsections in which insurance coverages for different buildings may be indicated on the form 1000. The first coverages subsection is indicated by the Coverages[1] sub-field 1006 of the general Coverages[] field 1004, the second subsection is indicated by the Coverages[2] sub-field 1008 of the general Coverages[] field 1004, and the third subsection is indicated by the Coverages[3] sub-field 1010 of the general Coverages[] field 1004. However, if more than an additional three buildings need coverage, an additional overflow form will be utilized.

For example, if the number of content sub-items exceeds the array size of the field on the base form, then the policy issuance server determines how many overflow forms to use by dividing the amount the number of content sub-items exceeds the array size of the field on the base form by the array size of the corresponding field on the overflow form (rounding up to the next whole number). In the present example, say there are five content sub-items corresponding to five different building which need coverage as indicated in the policy data received by the policy issuance server from the general agent system.

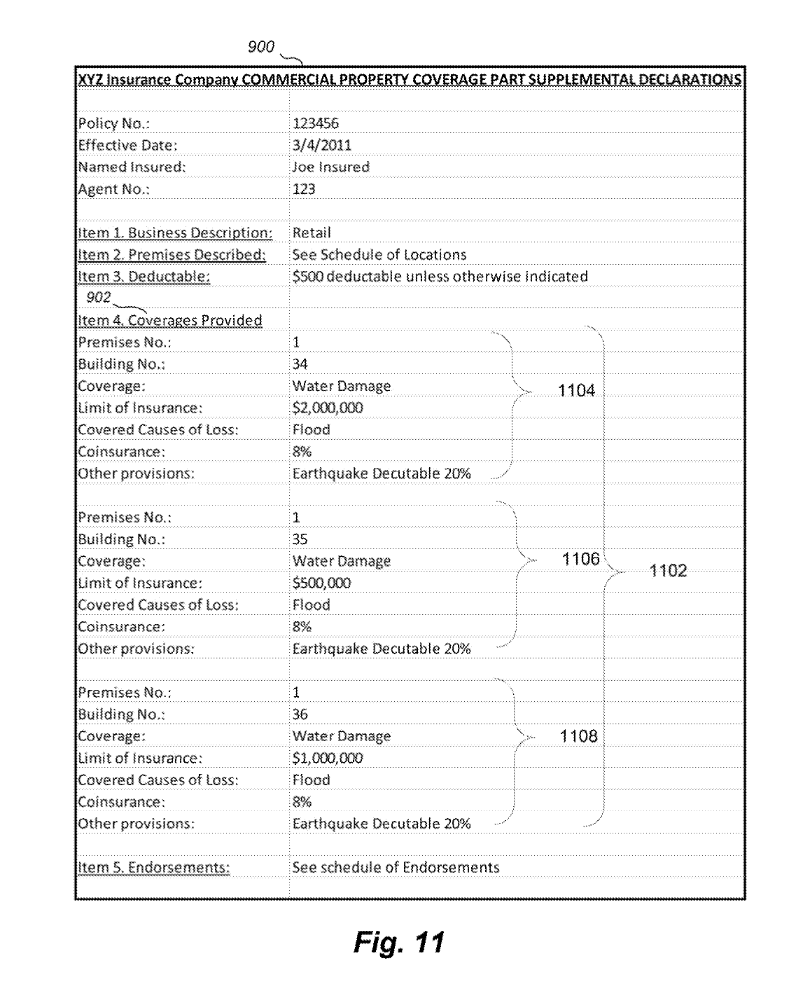

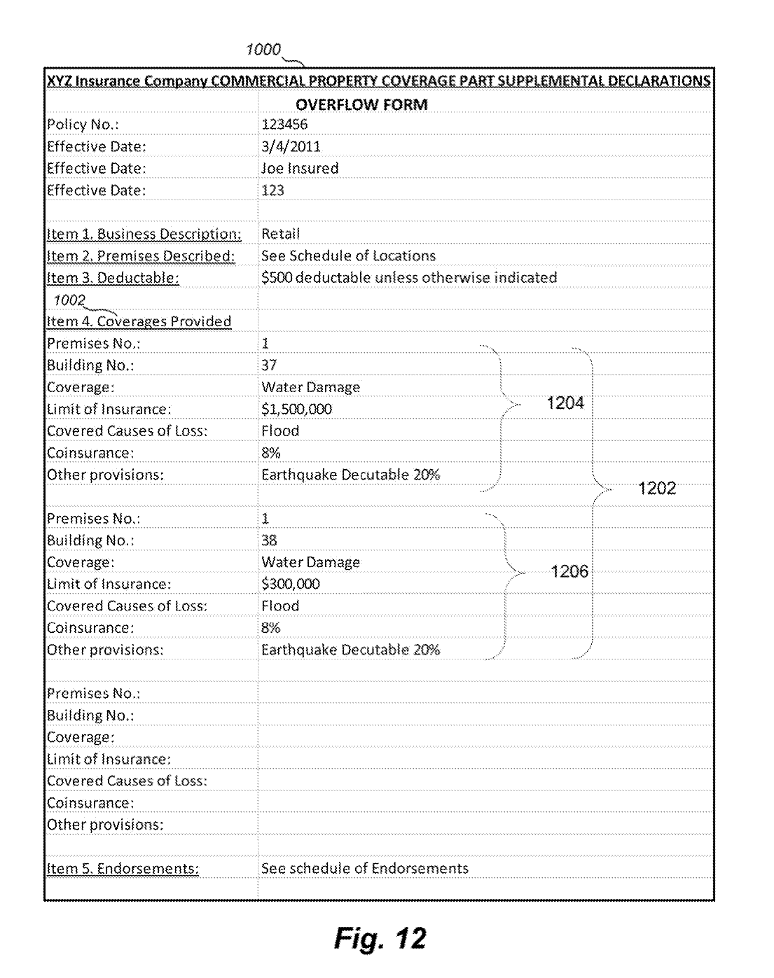

As shown above, the array size of the Coverages[] field 904 on the base form 900 is three. The array size of the general Coverages[] field 1004 on the designated overflow form 1000 is also three, although it may be larger or smaller in other embodiments. Thus, the amount the number of content sub-items exceeds the array size of the Coverages[] field 904 on the base form is five minus three, which equals two. Two divided by the array size, three, of the corresponding Coverages[] field 1004 on the overflow form is ⅔. This is then rounded up to the next whole number, one. Thus the number of overflow forms to be used is one. The result of the above example using sample data for five buildings that need coverage is shown in FIGS. 11 and 12.

FIGS. 11 and 12 are the example base form 900 of FIG. 9, and example overflow form 1000 of FIG. 10, respectively, populated with sample data 1102 resulting from the example provided above. Note that each subsection 1104 1106 1108 of the Coverages Provided 902 section on the base form 1000 is full. On the overflow form 1000, only two subsections 1204 1206 of the Coverages Provided 1002 section are populated with data 1202 as there are only five buildings total needing coverage resulting in five total content sub-items. The number of overflow forms may also depend on the number of other available fields on the form than the Coverages[] field 904 on the base form, in which case the number of overflow forms is the minimum number needed to accommodate the received policy content data taking into account the number of available fields of all the different types of fields. In one embodiment, this may be determined by repeating the above process described to determine the quantity of overflow forms for each field on the form and then selecting the largest determined quantity from those determined for each filed. Also, other different overflow forms may be used for one or more particular fields on the base form and the overflow forms may differ in appearance and layout than the associated base form.

Although the determining the number of overflow forms and generating the completed base forms and overflow forms is described above as being performed by the policy issuance server, these processes may be performed by other components or systems separate from the policy issuance server or located remotely form the policy issuance server. Also, although the policy data is described above as being generated by and received from the general agent system, the policy data may be generated by and received from other systems separate from the general agent system or located remotely form the general agent system.

The foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

In addition, those skilled in the art will appreciate that the mechanisms taught herein are capable of being distributed as a program product in a variety of forms, and that an illustrative embodiment applies equally regardless of the particular type of signal bearing media used to actually carry out the distribution. Examples of signal bearing media include, but are not limited to, the following: recordable type media such as floppy disks, hard disk drives, CD ROMs, digital tape, and computer memory.

The various embodiments described above can be combined to provide further embodiments. To the extent that they are not inconsistent with the specific teachings and definitions herein, all of the U.S. patents, U.S. patent application publications, U.S. patent applications, foreign patents, foreign patent applications and non-patent publications referred to in this specification are incorporated herein by reference, in their entirety, including U.S. Provisional Patent Application No. 61/422,090, field Dec. 10, 2010. Aspects of the embodiments can be modified, if necessary, to employ systems, circuits and concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A computer-implemented method, comprising:
determining by at least one processor that an electronically stored form is an overflow form for a base form, wherein the overflow form and base form are electronically stored forms;
recording on a non-transitory storage medium a relationship between the overflow form and the base form based on the determination that that the particular electronically stored form is an overflow form for the particular electronically stored base form;
electronically tagging one or more fields on the base form and the overflow form according to a naming convention;
receiving data with which to populate the one or more fields of the base form or overflow form; and
automatically determining by the at least one processor a quantity of electronically stored overflow forms to use corresponding to the overflow form to accommodate the received data based on an amount of the received data and based at least in part on the naming convention.

2. The method of claim 1 further comprising:
automatically populating the base form and the determined quantity of overflow forms with the received data.

3. The method of claim 2 further comprising:
electronically making available to a remote entity the base form and the determined quantity of overflow forms for validation.

4. The method of claim 1 wherein the automatically determining by at least one processor the quantity of electronically stored overflow forms to use comprises:
determining whether a quantity of content sub-items of the received data corresponding to a field on the base form exceeds an array size of the field on the base form as indicated by an index number within a tag used to identify a last sub-field within the array on the base form; and
if the quantity of content sub-items exceeds the array size of the field on the base form, then determining the quantity of overflow forms to use by:
dividing an amount that the quantity of content sub-items exceeds the array size of the field on the base form by an array size of a corresponding field on an overflow form corresponding to the field on the base form to generate a resulting number; and
rounding the resulting number up to the next whole number if the resulting number is not a whole number.

5. The method of claim 4 further comprising repeating the determining whether the quantity of content sub-items of the received data corresponding to the field on the base form exceeds the array size and the determining the quantity of overflow forms to use, for each field of the base form.

6. The method of claim 5 wherein one or more fields of the base form have different corresponding overflow forms.

7. The method of claim 5 further comprising:
automatically selecting a largest determined quantity of overflow forms from the determined quantities of overflow forms to use for each field; and
using the selected largest quantity as a quantity of overflow forms to use for the base form.

8. The method of claim 1 wherein the base form and the overflow forms are electronically stored insurance policy forms and the received data includes one or more of insurance customer data and insurance customer property data.

9. A system, comprising:
a computer processor; and
a non-transitory memory communicatively coupled to the computer processor having computer-executable instructions stored thereon that when executed by the computer processor cause the computer processor to perform:
determining that an electronically stored form is an overflow form for a base form, wherein the overflow form and base form are electronically stored forms;
determining a quantity of electronically stored overflow forms to use corresponding to the overflow form to accommodate received data with which to populate the base form and the overflow form, based on an amount of the received data and based at least in part on a naming convention for tags of fields on the base form and tags of fields on the overflow form; and
automatically populating the base form and the determined quantity of overflow forms with at least a portion of the received data.

10. The system of claim 9, wherein the computer-executable instructions, when executed by the computer processor, further cause the computer processor to perform:
receiving an indication that a particular electronically stored form is the overflow form for the base form; and
recording a relationship between the overflow form and the base form based on the received indication.

11. The system of claim 10, wherein the computer-executable instructions, when executed by the computer processor, further cause the computer processor to perform electronically tagging the fields on the base form and the fields on the overflow form according to the naming convention.

12. The system of claim 9 wherein determining the quantity of electronically stored overflow forms to use comprises:
determining whether a quantity of content sub-items of the received data corresponding to a field on the base form exceeds an array size of the field on the base form as indicated by an index number within a tag used to identify a last sub-field within the array on the base form; and
if the quantity of content sub-items exceeds the array size of the field on the base form, then determining the quantity of overflow forms to use by dividing an amount that the quantity of content sub-items exceeds the array size of the field on the base form by an array size of a corresponding field on an overflow form corresponding to the field on the base form to generate a resulting number; and
rounding the resulting number up to the next whole number if the resulting number is not a whole number.

13. The system of claim 9 wherein the base form and the overflow forms are electronically stored insurance policy forms and the received data includes one or more of insurance customer data and insurance customer property data.

14. A non-transitory computer readable storage medium, having computer computer-executable instructions stored thereon that when executed by a computer processor cause the computer processor to perform:
determining a quantity of available fields on a base form and an overflow form associated with the base form based at least in part on a naming convention for tags of fields of the base form and tags of fields of the overflow form, wherein the overflow form and the base form are electronically stored forms; and
automatically determining, based on the determined quantity of available fields on the base form and the overflow form, a quantity of electronically stored overflow forms to use corresponding to the overflow form to accommodate received data with which to populate the base form and overflow forms.

15. The non-transitory computer readable storage medium of claim 14, wherein the computer-executable instructions, when executed by the computer processor, further cause the computer processor to perform:
electronically receiving one or more electronically stored forms;
receiving an indication that a particular form is the overflow form associated with the base form, one or more of the overflow form and base form being of the received one or more electronically stored forms; and
recording a relationship between the overflow form and the base form based on the received indication.

16. The non-transitory computer readable storage medium of claim 14, wherein the computer-executable instructions, when executed by the computer processor, further cause the computer processor to perform electronically tagging fields on the base form and overflow form according to the naming convention.

17. The non-transitory computer readable storage medium of claim 14 wherein the determining a quantity of available fields on the base form and the overflow form based at least in part on the naming convention comprises:
determining an array size of a field on the base form as indicated by an index number within a tag used to identify a last sub-field within the array on the base form.

18. The non-transitory computer readable storage medium of claim 17 wherein the automatically determining, based on the determined quantity of available fields on the base form and the overflow form, the quantity of electronically stored overflow forms to use comprises:
if a quantity of content sub-items of the received data corresponding to the field on the base form exceeds the array size of the field on the base form, then determining the quantity of overflow forms to use by:
dividing an amount that the quantity of content sub-items exceeds the array size of the field on the base form by an array size of a corresponding field on an overflow form corresponding to the field on the base form to generate a resulting number; and
rounding the resulting number up to the next whole number if the resulting number is not a whole number.

19. The non-transitory computer readable storage medium of claim 14 wherein the base form and the overflow forms are electronically stored insurance policy forms and the received data includes one or more of insurance customer data and insurance customer property data.

20. The non-transitory computer readable storage medium of claim 14, wherein the computer-executable instructions, when executed by the computer processor, further cause the computer processor to perform electronically making available to a remote entity a completed base form and a completed determined quantity of overflow forms for validation.
